(19) United States
(12) Patent Application Publication
(10) Pub. No.: US 2019/0094817 A1
(43) Pub. Date: Mar. 28, 2019

(54) PORTABLE RADIO-CONTROLLED WATCH

(71) Applicant: CITIZEN WATCH CO., LTD., Tokyo (JP)

(72) Inventors: Ken KITAMURA, Nishitokyo-shi, Tokyo (JP); Akira KATO, Tokorozawa-shi, Saitama (JP); Shuji NAKA, Fuchu-shi, Tokyo (JP); Yohsuke NOMA, Koshigaya-shi, Saitama (JP)

(21) Appl. No.: 16/084,560

(22) PCT Filed: Mar. 16, 2017
(86) PCT No.: PCT/JP2017/010764

§ 371 Date: Sep. 13, 2018

(30) Foreign Application Priority Data
Mar. 29, 2016 (JP) 2016-066526

(51) Int. Cl. G04R 20/04; G04R 60/02; G04R 60/08; G04R 60/10; G04G 21/04

(52) U.S. Cl. CPC G04R 20/04; G04R 60/02; G04G 21/04; G04R 60/10; G04R 60/08

(57) ABSTRACT

A portable radio-controlled watch includes a watch glass, an antenna electrode that is formed on a backside of a peripheral edge of the watch glass so as to be along the peripheral edge, a receiving circuit, an antenna connecting line that is at least a part of a connection circuit connecting the antenna electrode with the receiving circuit, the antenna connecting line being directly connected to a back surface of the antenna electrode and extending in a direction away from the watch glass, and a dielectric that is disposed below the antenna electrode and covers at least a part of the antenna electrode in a plan view.

### TECHNICAL FIELD

The present invention relates to a portable radio-controlled watch that receives a signal from a satellite, for example.

### BACKGROUND ART

Portable radio-controlled watches that receive time information in a transmission signal from a satellite configuring GPS (Global Positioning System), for example, to correct time have increased their practical applications. Types and placement of antennas for receiving radio waves are determined so as not to deteriorate the operability of the watch and to obtain necessary reception sensitivity.

FIG. 8 of Patent Literature 1 discloses placing the parasitic element 423 (antenna) in the backside of the outer peripheral edge of the watch glass. The parasitic element 423 is fed by the arc-shaped fed element 410 formed on the dielectric in a non-contact manner. The dial ring 83, which is a dielectric, is disposed between the parasitic element 423 and the fed element 410.

Patent Literature 2 discloses the antenna 40 including the parasitic element 402 and the driven element 403 disposed on the annular dielectric 401. The antenna is not disposed on the watch glass, and the dial ring 83 is disposed between the antenna 40 and the watch glass.

### CITATION LIST

### Patent Literature

Patent Literature 1: JP2014-163666A

Patent Literature 2: JP2014-62844A

### SUMMARY OF INVENTION

### Technical Problem

The inventors of the present invention consider including a highly sensitive annular antenna for a UHF band in a portable watch, such as a wristwatch. In this case, the wavelength needs to be shortened by the dielectric so that the antenna is accommodated in the portable watch. Here, as shown in FIG. 8 of Patent Literature 1, if the dielectric is disposed between the parasitic element (antenna) and the fed element, a loss will occur in the high-frequency received signal by the dielectric. Further, even without the dielectric, the reception sensitivity can be lowered due to the distance. On the other hand, as indicated in Patent Literature 2, if the antenna is disposed at the position away from the watch glass, the antenna is affected by the case or the circuit of the portable watch, which results in lowered sensitivity or increased thickness.

One or more embodiments of the present invention have been conceived in view of the above, and an object thereof is to provide a highly sensitive and thin portable radio-controlled watch.

### Solution to Problem

(1) A portable radio-controlled watch includes a watch glass, an antenna electrode that is formed on a backside of a peripheral edge of the watch glass so as to be along the peripheral edge, a receiving circuit, an antenna connecting line that is at least a part of a connection circuit connecting the antenna electrode with the receiving circuit, the antenna connecting line being directly connected to a back surface of the antenna electrode and extending in a direction away from the watch glass, and a dielectric that is disposed below the antenna electrode and covers at least a part of the antenna electrode in a plan view.

(2) In (1), the portable radio-controlled watch further includes a bezel into which the watch glass is fitted, and the dielectric is a part of the bezel and disposed immediately below the antenna electrode.

(3) In (1), the portable radio-controlled watch further includes a bezel into which the watch glass is fitted, and the dielectric is a part of the bezel, and an insulating member is disposed between the antenna electrode and the dielectric.

(4) In (1), the portable radio-controlled watch further includes a bezel into which the watch glass is fitted and includes a dielectric disposed below the antenna electrode, and a dielectric member that is disposed between the dielectric and the antenna and has a different permittivity than the dielectric.

(5) In (1), the portable radio-controlled watch further includes a bezel into which the watch glass is fitted and includes a metal member and a dielectric member.

(6) In (1) to (5), the portable radio-controlled watch further includes a hiding member between the antenna electrode and the watch glass.

(7) In (1) to (6), in the portable radio-controlled watch a peripheral edge of the watch glass is inclined in a front side.

### Effects of the Invention

According to the present invention, it is possible to provide a thin portable radio-controlled watch that receives radio wave at a high sensitivity.

### BRIEF DESCRIPTION OF DRAWINGS

FIG. 1 is a plan view illustrating an example of a satellite radio-controlled wristwatch according to an embodiment of the present invention;

FIG. 2 is a cross-sectional view of the satellite radio-controlled wristwatch shown in FIG. 1 taken along the line II-II;

FIG. 3 is a plan view of a circuit substrate and a balun substrate included in the satellite radio-controlled wristwatch shown in FIG. 1;

FIG. 4 is a block diagram illustrating a schematic circuit configuration of the satellite radio-controlled wristwatch;

FIG. 5 is a partial enlarged view of the cross section shown in FIG. 2;

FIG. 6 is a partial plan view of a bezel and a dial ring;

FIG. 7 is a cross-sectional view of the satellite radio-controlled wristwatch shown in FIG. 1 taken along the line VII-VII;

FIG. 8 is a partial sectional view of another example of the satellite radio-controlled wristwatch;

FIG. 9 is a partial sectional view of another example of the satellite radio-controlled wristwatch;

FIG. 10 is a partial sectional view of another example of the satellite radio-controlled wristwatch;

FIG. 11 is a partial sectional view of another example of the satellite radio-controlled wristwatch;

FIG. 12 is a partial sectional view of another example of the satellite radio-controlled wristwatch;

FIG. 13 is a partial sectional view of another example of the satellite radio-controlled wristwatch;

FIG. 14 is a partial sectional view of another example of the satellite radio-controlled wristwatch;

FIG. 15 is a partial sectional view of another example of the satellite radio-controlled wristwatch;

FIG. 16 is a partial sectional view of another example of the satellite radio-controlled wristwatch;

FIG. 17 is a partial sectional view of another example of the satellite radio-controlled wristwatch;

FIG. 18 is a partial sectional view of another example of the satellite radio-controlled wristwatch;

FIG. 19 is a partial sectional view of another example of the satellite radio-controlled wristwatch;

FIG. 20 is a partial sectional view of another example of the satellite radio-controlled wristwatch;

FIG. 21 is a partial sectional view of another example of the satellite radio-controlled wristwatch;

FIG. 22 is a partial sectional view of another example of the satellite radio-controlled wristwatch; and

FIG. 23 is a partial sectional view of another example of the satellite radio-controlled wristwatch.

### DESCRIPTION OF EMBODIMENTS

An embodiment of the present invention will be described below in detail with reference to the accompanying drawings. In the following, a satellite radio-controlled wristwatch 1 according to an embodiment of the present invention will be described. The satellite radio-controlled wristwatch 1 according to this embodiment receives a satellite radio wave including time information, and, by using time information included in the received satellite radio wave, the satellite radio-controlled wristwatch 1 adjusts time that the satellite radio-controlled wristwatch 1 counts and measures position.

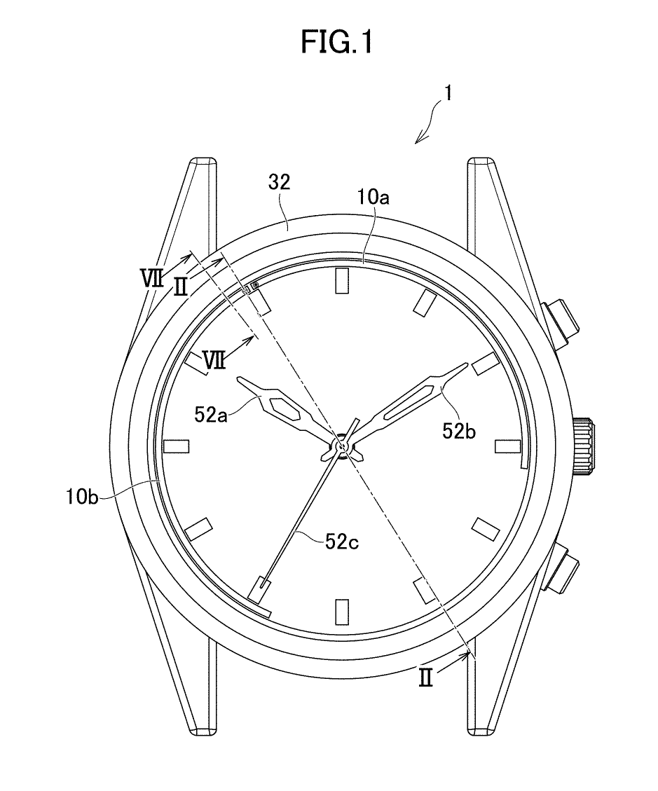

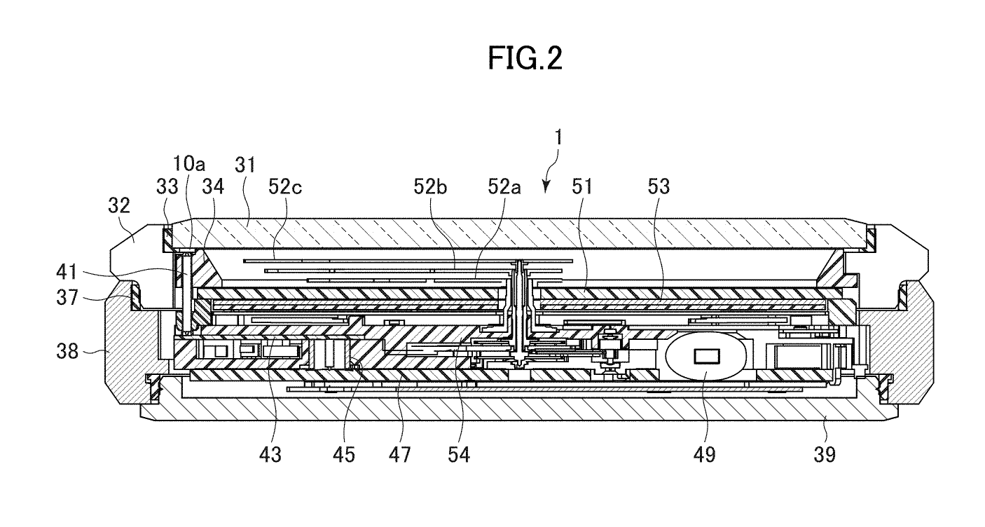

FIG. 1 is a plan view illustrating an example of an appearance of the satellite radio-controlled wristwatch 1 according to an embodiment of the present invention. FIG. 2 is a cross-sectional view of the satellite radio-controlled wristwatch 1 shown in FIG. 1 taken along the line II-II. As shown in FIGS. 1 and 2, the satellite radio-controlled wristwatch 1 includes a watch glass 31, a bezel 32 for holding the watch glass 31, a cylindrical body 38, and a back cover 39 below the body 38. These configure the outline of the satellite radio-controlled wristwatch 1. The body 38 and the bezel 32 are disposed between the watch glass 31 and the back cover 39. In the following, a direction from the center of the satellite radio-controlled wristwatch 1 to the watch glass 31 is described as “up”, “upper”, “upward”, and “top”, and a direction to the back cover 39 is described as “low”, “lower”, “downward”, “below”, and “bottom”, for example.

The body 38 is made of metal, and has a hole in each of the upper side and the lower side. The bezel 32 is annular ceramics corresponding with the shape of the upper hole of the body 38, and is fitted into the upper hole, thereby connecting the body 38. The back cover 39 is made of metal, and has a plane corresponding with the shape of the lower hole of the body 38. The back cover 39 is fitted into the lower hole. The watch glass 31 has a planar shape corresponding with a shape of an upper opening of the bezel 32, and is fitted into the opening of the bezel 32. The watch glass 31 is in contact with the bezel 32 through a packing 33, and the watch glass 31 is fixed using the packing 33. The bezel 32 is in contact with the body 38 through the packing 37, and the bezel 32 is fixed using the packing 37.

The satellite radio-controlled wristwatch 1 includes antennas 10a and 10b, two conductive pins 41, an annular dial ring 34, a dial plate 51, an hour hand 52a, a minute hand 52b, a second hand 52c, a solar cell 53, a main plate 54, a balun substrate 43, a coaxial pin 45, a circuit substrate 47, and a motor 49. These are disposed in space surrounded by the watch glass 31, the bezel 32, the body 38, and the back cover 39.

The antennas 10a and 10b are disposed below (back of) the watch glass 31 so as to extend along the peripheral edge of the watch glass 31. In the example of FIG. 1, each of the antennas 10a and 10b is arc-shaped, and bonded to the backside of the watch glass 31. The antennas 10a and 10b receive satellite signals from the satellite. In particular, in this embodiment, the antennas 10a and 10b are what we call dipole antennas, and receive radio wave having a frequency of about 1.6 GHz transmitted from a Global Positioning System (GPS) satellite. GPS is a type of satellite positioning system, which is constructed by GPS satellites orbiting around the earth.

The conductive pins 41 are what we call probe pins. The two conductive pins 41 correspond to the antennas 10a and 10b on a one-to-one basis, and each of the antennas 10a and 10b is electrically connected to the balun substrate 43 by a corresponding conductive pin 41. Each end of a conductive pin 41 is elastic by a spring, and upper ends of the two conductive pins 41 are in contact with the antennas 10a and 10b. The lower ends of the two conductive pins 41 are in contact with two connecting terminals provided on the balun substrate 43. The two conductive pins 41 are fixed in a plan view using the dial ring 34 and the main plate 54, and are disposed in parallel to each other. In the example of FIG. 2, the conductive pins 41 are fixed in a hole vertically penetrating the dial ring 34. When viewed from the antennas 10a and 10b, the conductive pins 41 extend in a direction away from the watch glass 31.

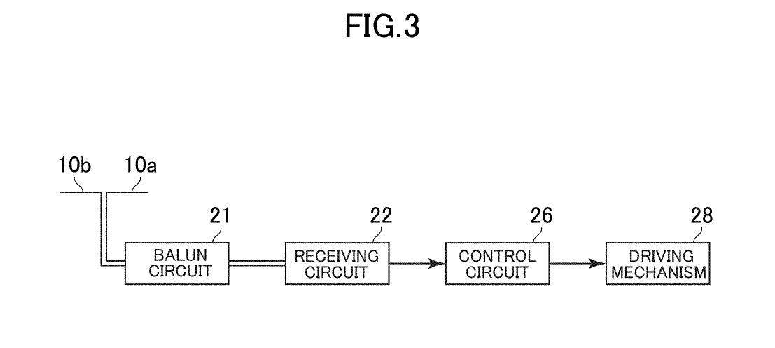

FIG. 3 is a block diagram showing a schematic circuit configuration of the satellite radio-controlled wristwatch 1. The balun circuit 21 converts signals received by the antennas 10a and 10b so that a balanced antenna, such as a dipole antenna, is connected with a coaxial pin 45 and a receiving circuit 22, each having unbalanced properties. The receiving circuit 22 is connected with the balun circuit 21 through the coaxial pin 45. The receiving circuit 22 decodes the signal received by the antennas 10a and 10b, and outputs a bit string (received data) indicating content of a satellite signal obtained by the decoding result. More specifically, the receiving circuit 22 includes a high frequency circuit (RF circuit) and a decoding circuit. The high frequency circuit operates at high frequency, and amplifies and demodulates an analog signal received by the antennas 10a and 10b to convert the analog signal into a baseband signal. The decoding circuit decodes the baseband signal output from the high frequency circuit to generate a bit string indicating data received from the GPS satellite, and outputs the bit string to the control circuit 26.

The control circuit 26 controls the circuits and the system included in the satellite radio-controlled wristwatch 1, and includes a microcontroller, a motor drive circuit, and an RTC (Real Time Clock), for example. The control circuit 26 acquires a time based on the received data and a clock output from the RTC, and drives the motor 49 included in a driving mechanism 28 in accordance with the acquired time. The driving mechanism 28 includes the motor 49, which is a stepping motor, and a gear train. The motor 49 is provided on a surface of the circuit substrate 47 on the side of the dial plate 51. The gear train transmits rotation of the motor 49, thereby causing one of the hour hand 52a, the minute hand 52b, and the secondhand 52c to turn, for example. The current time is displayed in this way.

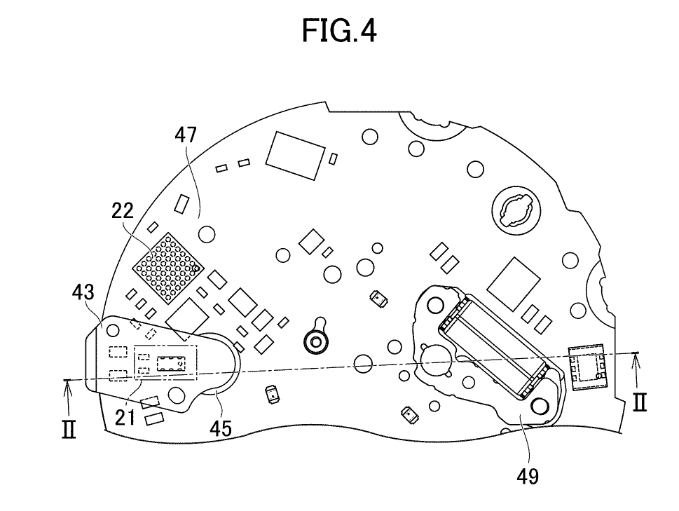

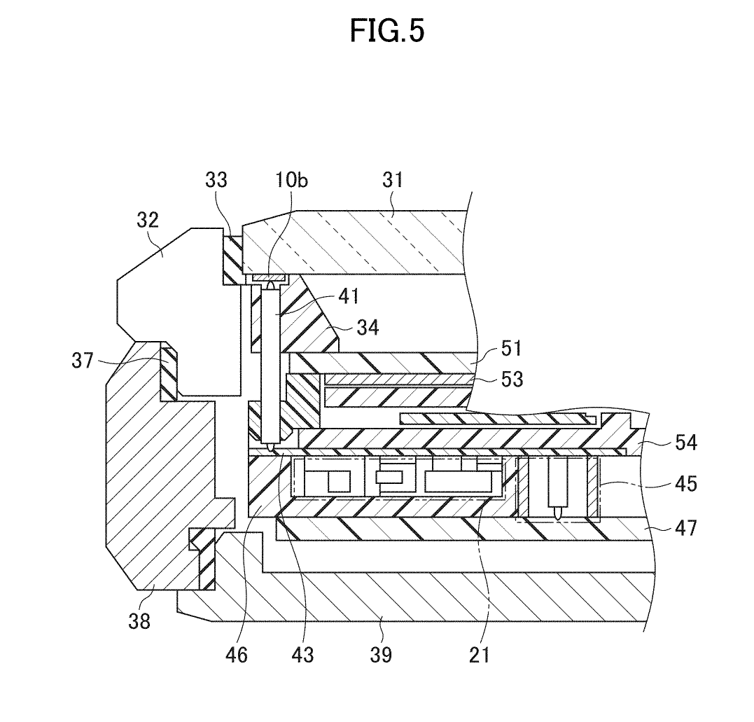

Next, placement of the balun circuit 21 and the receiving circuit 22 etc. will be described. FIG. 4 is a plan view of the circuit substrate 47 and the balun substrate 43 included in the satellite radio-controlled wristwatch 1 shown in FIG. 1. The cutting line II-II shown in FIG. 4 corresponds to the cross section shown in FIG. 2. FIG. 5 is a partial enlarged view of the cross section shown in FIG. 2. The balun substrate 43 is disposed on the circuit substrate 47. The balun circuit 21 connected to the antennas 10a and 10b is disposed on the bottom surface of the balun substrate 43, and the receiving circuit 22 is disposed on the circuit substrate 47. In the example of FIG. 4, the receiving circuit 22 is disposed next to the balun substrate 43 in a plan view. The balun substrate 43 does not overlap the motor 49 and a battery in a plan view.

A spacer 46 made of resin is disposed between the balun substrate 43 and the circuit substrate 47, and keeps a space between the balun substrate 43 and the circuit substrate 47. The balun substrate 43 and the circuit substrate 47 are disposed in parallel to each other. The spacer 46 is disposed between the balun circuit 21 and the circuit substrate 47, but a metal member, such as a GND wiring, is not disposed between the balun circuit 21 and the circuit substrate 47. The solar cell 53 is disposed immediately below the dial plate 51, and, for example, a main plate 54 is disposed between the solar cell 53 and the balun substrate 43 or the circuit substrate 47.

The antennas 10a and 10b are connected to the balun circuit 21 through intermediate wiring on the conductive pins 41 and the balun substrate 43. The intermediate wiring extends from the connecting terminal of the conductive pins 41 on the balun substrate 43. When viewed from the connecting terminal, the intermediate wiring extends away from the body 38. The balun circuit 21 and the receiving circuit 22 are connected to each other by RF connection wiring. The RF connection wiring includes the coaxial pin 45, wiring on the balun substrate 43 for connecting the coaxial pin 45 and the balun circuit 21, and wiring on the circuit substrate 47 for connecting the coaxial pin 45 and the receiving circuit 22. The coaxial pin 45 electrically connects the wiring on the balun substrate 43 to the wiring on the circuit substrate 47. The coaxial pin 45 is closer to the center of the dial plate 51 than the conductive pins 41 in a plan view, and further away from the body 38 than the conductive pins 41. The conductive pins 41, the intermediate wiring, the balun circuit 21, and the RF connection wiring are a connection circuit that connects the antennas 10a and 10b with the receiving circuit 22. The conductive pins 41 are a type of wiring that connects the antennas 10a and 10b to the balun circuit 21.

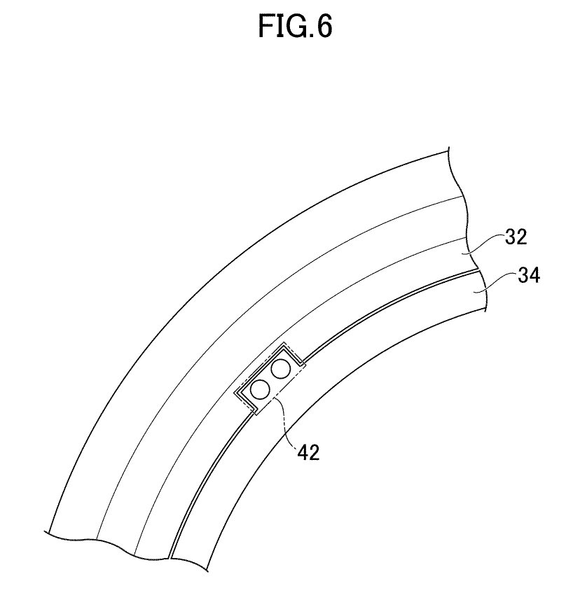

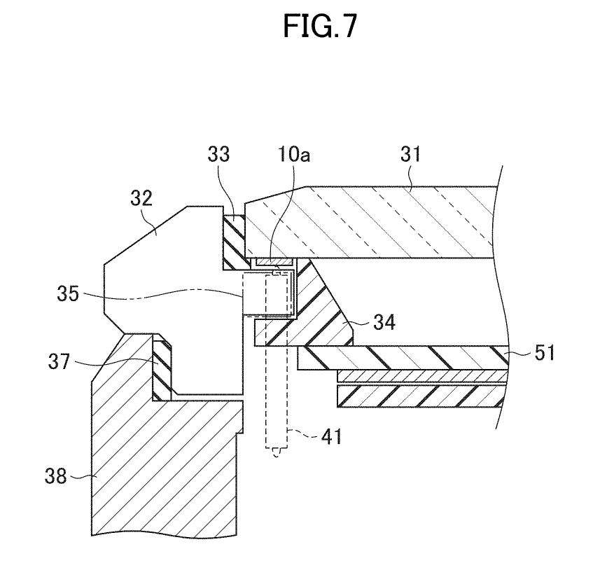

The bezel 32 has notch 42 at a position where the conductive pins 41 are inserted in an inner circumferential surface. FIG. 6 is a partial plan view of the bezel 32 and the dial ring 34. The bezel 32 includes a part outside the peripheral edge of the watch glass 31 in a plan view, and a projection 35 (see FIG. 7) projecting inward from the outside part. The notch 42 is provided on the projection 35 in the vicinity of the conductive pins 41. In a plan view, the dial ring 34 on the inner circumference side of the bezel 32 is provided at the position of the notch 42, and two holes are provided in an area where the dial ring 34 overlaps the notch 42 so as to fix the conductive pins 41. The two conductive pins 41 are disposed so as to be inserted into the two holes.

Next, the antennas 10a and 10b and the peripheral members will be described in more detail. FIG. 7 is a cross-sectional view of the satellite radio-controlled wristwatch 1 shown in FIG. 1 taken along the line VII-VII. In FIG. 7, the conductive pins 41 are not on the cross section, and indicated in dashed line.

The bezel 32 is formed of ceramics having dielectric properties, and the projection 35 covers at least a part of the antennas 10a and 10b in the peripheral edge of the watch glass 31 in a plan view. The projection 35 is disposed immediately below at least a part of the antennas 10a and 10b, and formed in the shape of a notched ring. In the example of this embodiment, the projection 35 is disposed immediately below a part of the antennas 10a and 10b other than the part connected to the conductive pin 41. The dial ring 34 is made of an insulating material, such as resin, and disposed so as to be adjacent to the inner circumference of the bezel 32. The dial ring 34 is disposed so as to be adjacent and below the projection 35.

In this embodiment, antennas 10a and 10b are disposed on the backside of the watch glass 31, and the bezel 32 (in particular, projection 35), which is a dielectric, is disposed below the antennas 10a and 10b. In this embodiment, the dielectric (here, bezel 32) below the antennas 10a and 10b provides an effect of reducing wavelength. Further, the conductive pins 41 and the antennas 10a and 10b are directly connected to each other, thereby preventing decrease of sensitivity due to the dielectric. The satellite radio-controlled wristwatch 1 with this configuration can be more thinned with higher sensitivity compared to the one without this configuration.

As shown in FIG. 7, the peripheral edge of the watch glass 31 on the front side (upper surface) has an inclined area, and the antennas 10a and 10b are covered by the inclined area. A planar area, which has a normal line extending upward, is provided inner side of the inclined area. More specifically, in a plan view, the inclined area is provided from the edge of the watch glass 31 on the front side to a position on the inner side of the edge of the antennas 10a and 10b in radial direction. In the inclined area, the normal line is inclined outward from the top, and the outer edge of the inclined area is lower than the inner edge. This configuration makes the antennas 10a and 10b less visible, and serves to enhance the design. In the example of FIG. 7, an angle of the inclination of the inclined area is constant in the cross section through the center of the satellite radio-controlled wristwatch 1.

The relationship between the antennas 10a and 10b and the dielectric may be different from the description above.

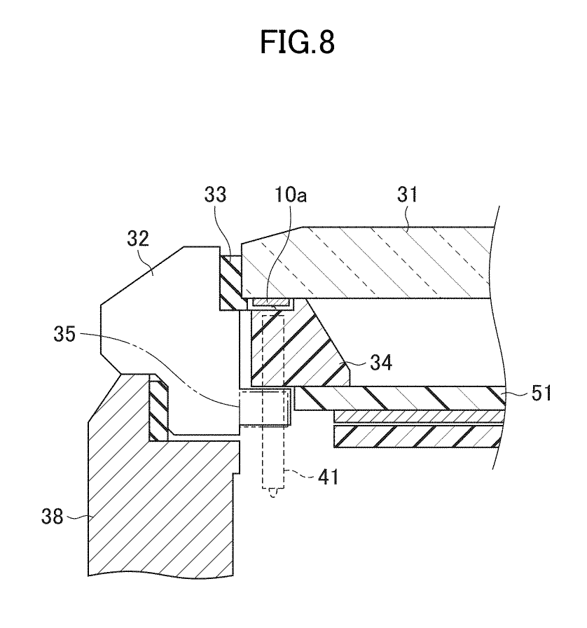

FIG. 8 is a partial sectional view of another example of the satellite radio-controlled wristwatch 1, and a cross-sectional view corresponding to FIG. 7. In the following, a difference between examples of FIG. 7 and FIG. 8 will be mainly described. In the example of FIG. 8, the dial ring 34 is disposed between the projection 35 and the antennas 10a and 10b. As such, in the example of FIG. 8, the projection 35 of the bezel 32 is not disposed over the upper surface of the dial plate 51. In this regard, a part of the dial ring 34 opposing to the projection 35 may be thinned, and the surface of the projection 35 opposing to the dial ring 34 may be directed upward. In the example of FIG. 8, an effect of reducing wavelength using the dielectric is low compared to the example of FIG. 7, but it is possible to prevent the sensitivity from being lowered as is the case with the example of FIG. 7.

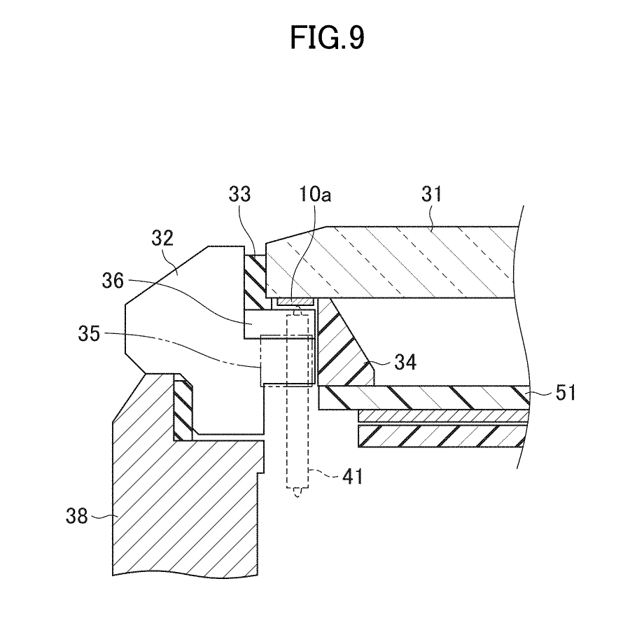

FIG. 9 is a partial sectional view of another example of the satellite radio-controlled wristwatch 1. FIG. 9 corresponds to FIG. 7, and a difference between examples of FIG. 7 and FIG. 9 will be mainly described below. In the example of FIG. 9, a high dielectric 36, which has a permittivity different from that of the projection 35, is disposed between the projection 35 and the antennas 10a and 10b. The high dielectric 36 is disposed immediately below the antennas 10a and 10b. The permittivity of the high dielectric 36 is preferably higher than that of the projection 35. The high dielectric 36 maybe formed of a material such as alumina or silicon nitride (permittivity 8 to 10), zirconia (permittivity 28 to 33), and titanium oxide (permittivity 60 to 100). The high dielectric 36 may be formed of other materials, such as ceramics and resin, having high permittivity. In the example of FIG. 9, an effect of reducing wavelength using the dielectric can be further provided, and the satellite radio-controlled wristwatch 1 can be made thinner and with higher sensitivity. In the example of FIG. 9, the dial ring 34 is always disposed inner side of the projection 35 in a plan view.

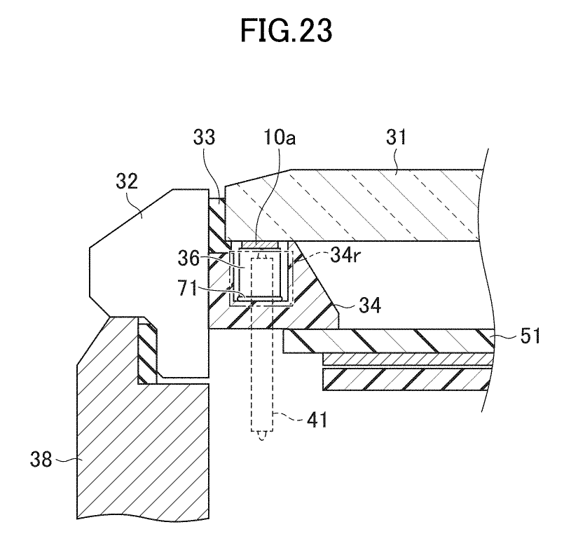

FIG. 23 is a partial sectional view of another example of the satellite radio-controlled wristwatch 1. FIG. 23 corresponds to FIG. 9, and a difference between examples of FIG. 23 and FIG. 9 will be mainly described below. In the example of FIG. 23, a recess 34r is provided in the upper part of the dial ring 34, and the high dielectric 36 is disposed inside of the recess 34r. The high dielectric 36 is generally made of a fragile material, such as ceramics. In the example of FIG. 23, the high dielectric 36 is provided independently from other members, and thus the position of the high dielectric 36 can be readily determined by the dial ring 34. This makes it easier to position the antennas 10a and 10b and the high dielectric 36, and to prevent manufacturing irregularities. Further, a cushioning material 71 is disposed between the bottom surface of the high dielectric 36 and the bottom of the recess 34r of the dial ring 34. The cushioning material 71 presses the high dielectric 36 against the antennas 10a and 10b so that the high dielectric 36 is in contact with the antennas 10a and 10b. The antennas 10a and 10b are in contact with the high dielectric 36 by the cushioning material 71, which serves to more securely provide an effect of reducing wavelength by the permittivity. With the use of the cushioning material 71, an impact to the fragile high dielectric 36 can be reduced, which can decrease the possibility of breakage of the satellite radio-controlled wristwatch 1. In this regard, an elastic member, such as a spring, may be disposed instead of the cushioning material 71.

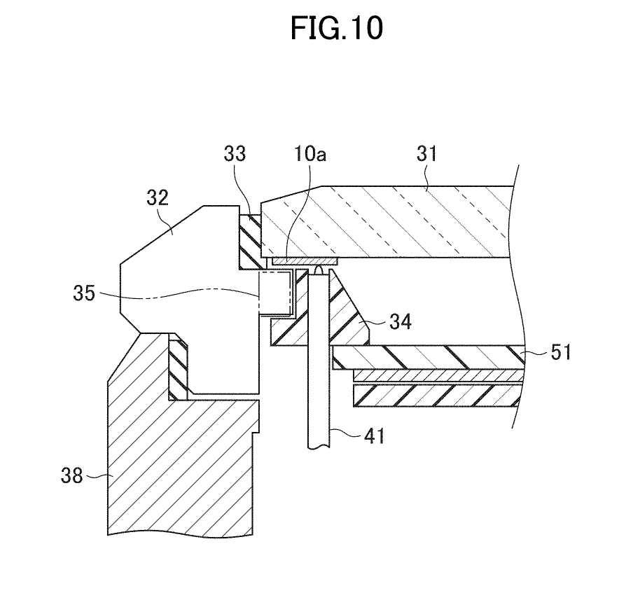

The antennas 10a and 10b may be wider at a part that is connected to the conductive pin 41. FIG. 10 is a partial sectional view illustrating another example of the satellite radio-controlled wristwatch 1 and corresponds to FIG. 5. In the example of FIG. 10, a projection 35 is also disposed at an area in the vicinity of the conductive pins 41, and the conductive pins 41 are disposed further inwardly compared to the example of FIG. 5. In a plan view, an area that is not covered by the projection 35 is provided inner side of the antennas 10a and 10b and in the vicinity of the conductive pins 41 so that the conductive pins 41 can be connected to the antennas 10a and 10b. In the example of FIG. 10, the projection 35 can be provided in the entire inner circumference side of the bezel 32, which provides more durability and airtightness.

Here, unlike the example of FIG. 7, the upper surface of the watch glass 31 may be curved at least in the peripheral edge at a cross section through the center of the satellite radio-controlled wristwatch 1 so as to make the antennas 10a and 10b less obvious.

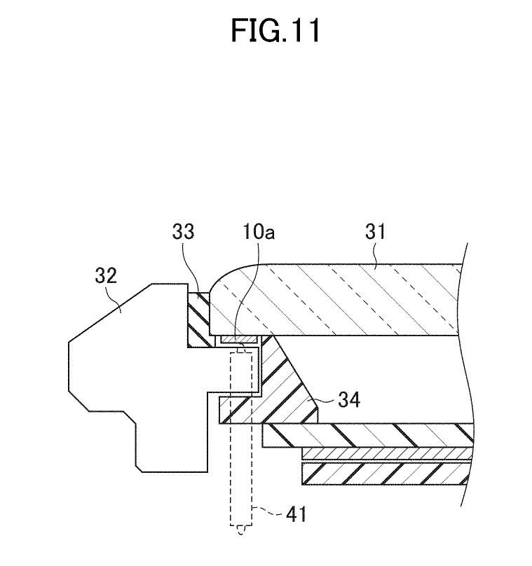

FIG. 11 is a partial sectional view illustrating another example of the satellite radio-controlled wristwatch 1, and corresponds to FIG. 7. In FIG. 11, unlike the example of FIG. 7, the side wall of the watch glass 31 and the planar area are connected to each other by a curved surface where the direction of the inclination (normal line) is successively changed. The curved surface is disposed in the same area as the inclined area of FIG. 7 in a plan view. In the example of FIG. 11 as well, the antennas 10a and 10b can be made less visible.

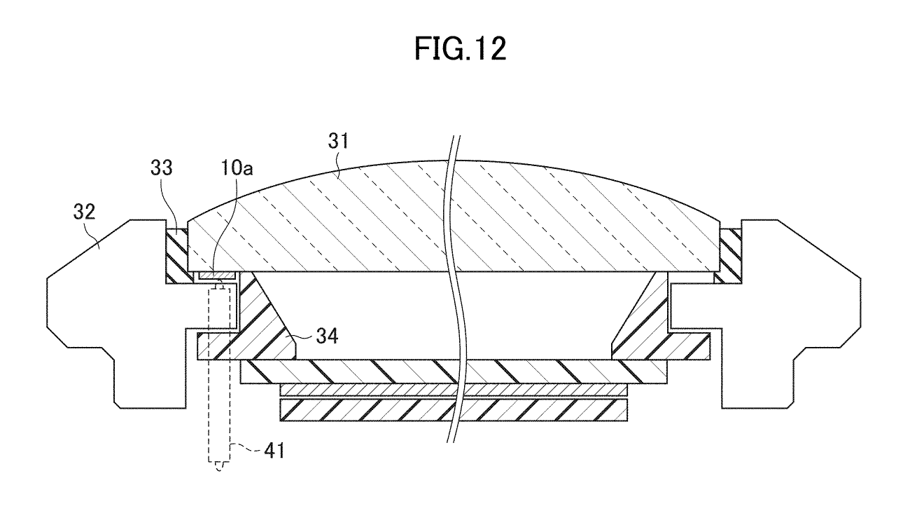

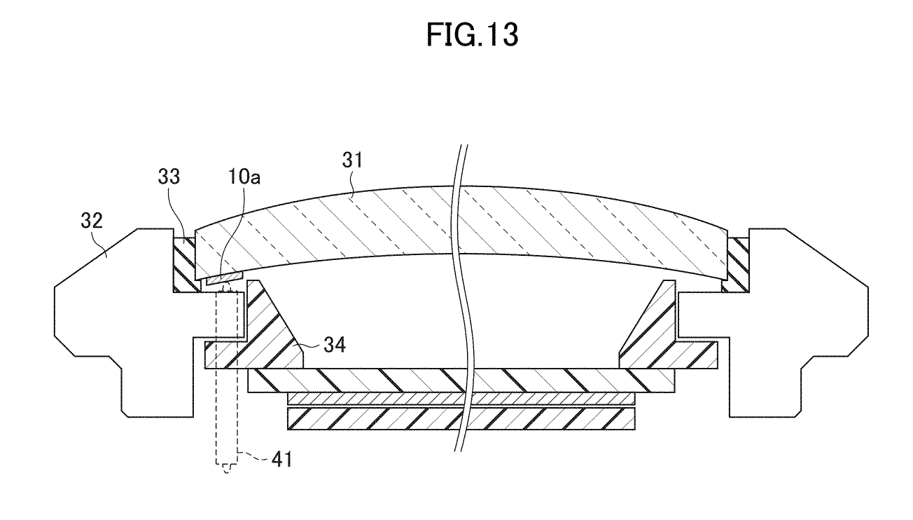

FIG. 12 is a partial sectional view illustrating another example of the satellite radio-controlled wristwatch 1, and corresponds to FIG. 7. In FIG. 12, unlike the example of FIG. 7, the entire upper surface of the watch glass 31 is a curved surface, and the peripheral edge of the upper surface of the watch glass 31 is lower than the center of the upper surface of the watch glass 31. FIG. 13 is a partial sectional view of another example of the satellite radio-controlled wristwatch 1 and corresponds to FIG. 12. In the example of FIG. 13, unlike the example of FIG. 12, the entire bottom surface of the watch glass 31 is also a curved surface, and the peripheral edge of the bottom surface of the watch glass 31 is lower than the center of the bottom surface of the watch glass 31. In the examples of FIGS. 12 and 13 as well, the antennas 10a and 10b can be made less visible.

Here, a hidden area may be provided on the surface of the watch glass 31 by printing or processing surface treatment so as to make the antennas 10a and 10b less obvious. With this method, the antennas 10a and 10b can also be made less visible.

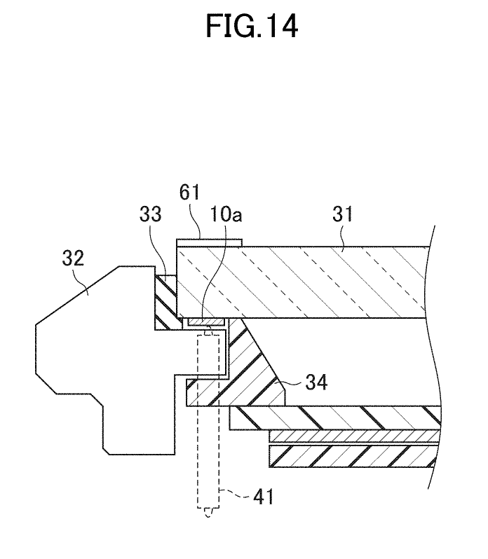

FIG. 14 is a partial sectional view of another example of the satellite radio-controlled wristwatch 1, and corresponds to FIG. 7. In FIG. 14, unlike the example of FIG. 7, the planar area having a normal line extending upward in the upper surface of the watch glass 31 covers the antennas 10a and 10b. Alternatively, a hiding area 61 formed by printing is provided in the peripheral edge of the upper surface of the watch glass 31. The hiding area 61 covers the antennas 10a and 10b. The hiding area 61 may be formed by processing the surface of the watch glass 31 to increase the reflectance.

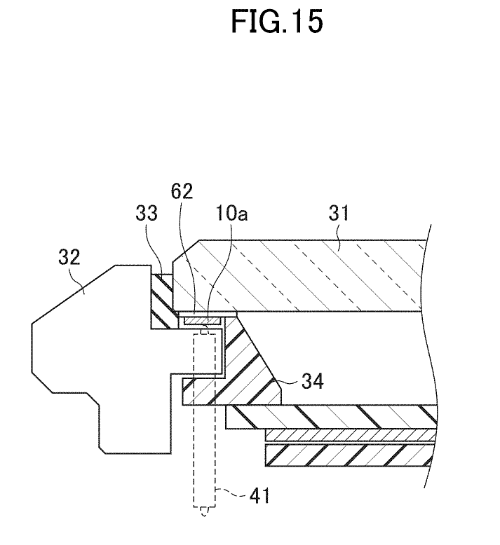

FIG. 15 is a partial sectional view illustrating another example of the satellite radio-controlled wristwatch 1, and corresponds to FIG. 14. In the example of FIG. 15, unlike the example of FIG. 14, the hiding area 62 is disposed so as to be in contact with the bottom surface of the watch glass 31, and covers the antennas 10a and 10b. More specifically, the hiding area 62 is formed by printing on the peripheral edge of the bottom surface of the watch glass 31, and the antennas 10a and 10b are adhered to the bottom surface of the hiding area 62. In the example of FIG. 15 as well, the hiding area 62 may be formed by processing the surface of the watch glass 31 so as to increase the reflectance. In this regard, printing or decorative printing indicative of information, such as cities, time-zone differences, memories, and receptions, may be provided between the hiding area 62 and the watch glass 31.

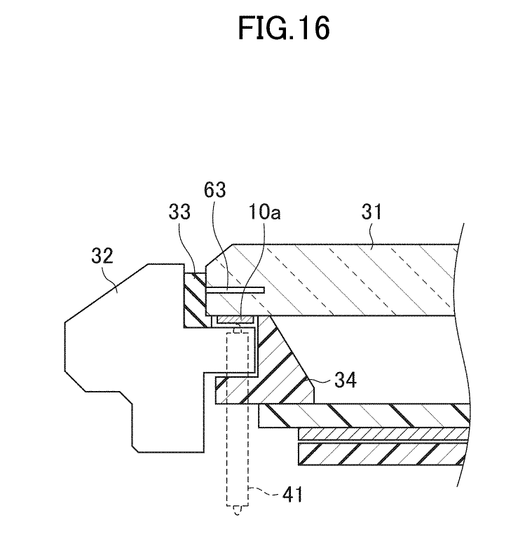

FIG. 16 is a partial sectional view of another example of the satellite radio-controlled wristwatch 1, and corresponds to FIG. 7. In FIG. 16, unlike the example of FIG. 7, the planar area having a normal line extending upward in the upper surface of the watch glass 31 covers the antennas 10a and 10b in a plan view. Alternatively, a groove is provided in the peripheral edge (side wall) between the upper surface and the bottom surface of the watch glass 31 so as to overlap the antennas 10a and 10b in a plan view, and a member is inserted in the groove. The member forms the hiding area 63. The hiding area 63 covers the antennas 10a and 10b.

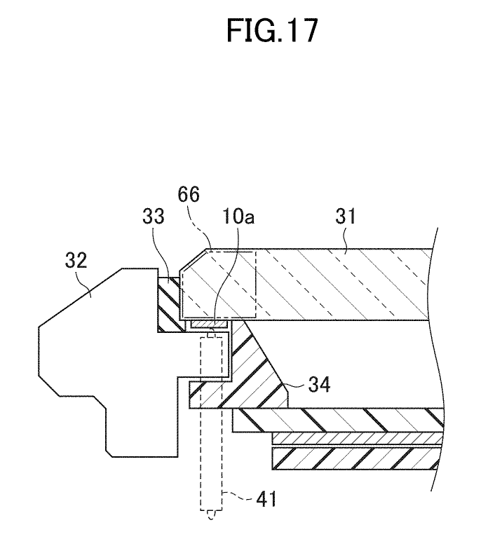

FIG. 17 is a partial sectional view of another example of the satellite radio-controlled wristwatch 1, and corresponds to FIG. 7. In the example of FIG. 17, the watch glass 31 includes a colored part 66 having a deeper color and greater reflectance or lower transmittance than other areas. The colored part 66 is the peripheral part of the watch glass 31, and covers the antennas 10a and 10b.

In the examples of FIGS. 14 to 17, the antennas 10a and 10b are covered by the hiding area so as not to be seen from the outside. In order to secure a light-receiving area of the solar cell 53, the hiding area is preferably disposed outside the solar cell 53 in a plan view.

In the examples described above, the entire bezel 32 is formed of ceramics, although the bezel 32 may include apart formed of a dielectric material, such as ceramics, and a part formed of metal, and these parts may be connected.

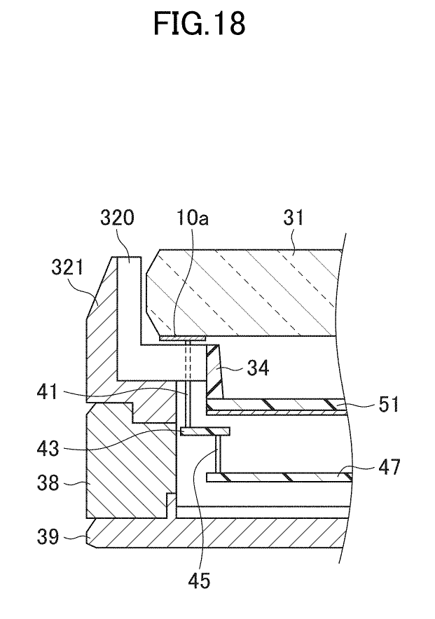

FIG. 18 is a schematic partial sectional view illustrating another example of the satellite radio-controlled wristwatch 1, and shows a cross section corresponding to FIG. 7. In the example of FIG. 18, unlike the example described in FIG. 7, the bezel 32 includes a dielectric part 320 formed of a dielectric material, such as ceramics, and a metal part 321 formed of metal. The dielectric part 320 is formed in a shape of a ring having a rectangular cross-section with an upper and inner rectangular area cut out. The watch glass 31 is fixed into the cut-out area. The dielectric part 320 includes an annular first part having an upper surface and a bottom surface in a plan view, and a second part extending upward from the outer peripheral edge of the first part. The first part overlaps the antennas 10a and 10b in a plan view. The second part is laterally adjacent to the antennas 10a and 10b. When viewed vertically, the antennas 10a and 10b are disposed between the upper end and the lower end of the second part. The metal part 321 includes a lateral part that is fitted into the body 38 and supports the first part of the dielectric part 320, and a longitudinal part that surrounds the side wall (outer side wall) of the dielectric part 320. The dial ring 34 is disposed so as to be in contact with the inner side wall of the second part of the dielectric part 320.

The bezel 32 is partially formed of a dielectric, such as ceramics, at apart close to the antennas 10a and 10b. This serves to provide a highly sensitive and thin satellite radio-controlled wristwatch 1. In addition, the bezel 32 is partially formed of metal, which serves to increase tolerance for impact. In particular, it is possible to allow two properties of high sensitivity and tolerance to coexist.

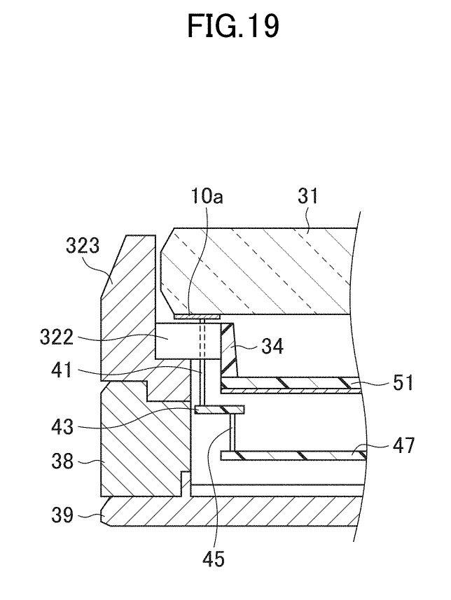

FIG. 19 is a schematic partial sectional view of another example of the satellite radio-controlled wristwatch 1 and corresponds to FIG. 18. In the example of FIG. 19, unlike the example of FIG. 18, a dielectric part 322 included in the bezel 32 does not have a part corresponding to the second part, and the dielectric part 322 is not laterally adjacent to the antennas 10a and 10b. The metal part 323 included in the bezel 32 includes a lateral part that is fitted into the body 38 and supports the first part of the dielectric part 322, and a longitudinal part that is adjacent to the side wall of the dielectric part 322 and the side wall of the watch glass 31 and constitutes the side wall of the bezel 32.

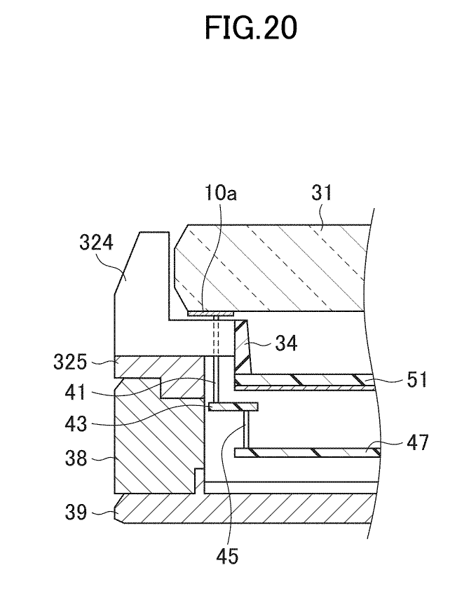

FIG. 20 is a schematic partial sectional view illustrating another example of the satellite radio-controlled wristwatch 1 and corresponds to FIG. 18. In the example of FIG. 20, a dielectric part 324 included in the bezel 32 includes an annular first part having an upper surface and a bottom surface in a plan view, and a second part extending upward from the edge of the peripheral edge of the first part. In the example of FIG. 20, unlike the example of FIG. 18, the dielectric part 324 also constitutes the side wall on the circumference of the bezel 32. The metal part 325 included in the bezel 32 is connected with the bottom surface of the dielectric part 324 and fitted into the body 38, and does not surround the side wall of the dielectric part 324.

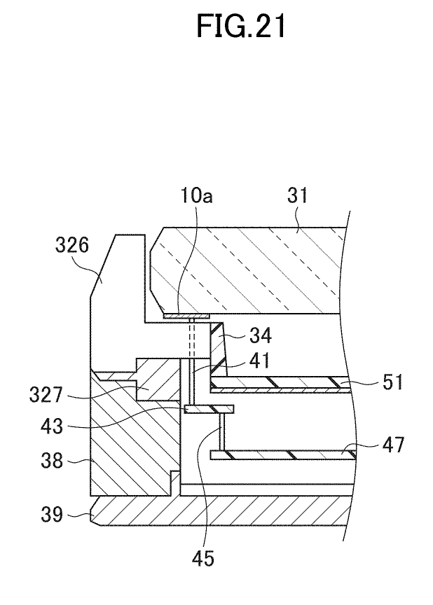

FIG. 21 is a schematic partial sectional view illustrating another example of the satellite radio-controlled wristwatch 1 and corresponds to FIG. 20. In the example of FIG. 21, similarly to the example of FIG. 20, a dielectric part 326 included in the bezel 32 also forms the side wall on the circumference of the bezel 32. In the example of FIG. 21, unlike the example of FIG. 20, the dielectric part 326 includes, in addition to an annular first part having an upper surface and a bottom surface in a plan view and a second part extending upward from the outer peripheral edge of the first part, a third part extending downward from the peripheral edge of the first part. Further, the lower end of the side wall of the third part is in contact with the upper end of the side wall on the circumference of the body 38, and a metal part 327 is not exposed on the side surface of the bezel 32. The metal part 327 is connected so as to be in contact with the bottom surface of the second part and the lower end of the side surface and the bottom surface of the third part, and fitted into the body 38. In the example of FIG. 21, the metal part 327 is not exposed, and thus a connected part of the metal part 327 and the dielectric part 326 can be made less visible.

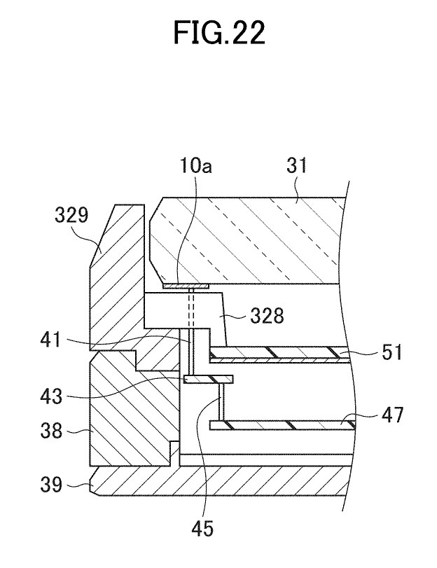

FIG. 22 is a schematic partial sectional view of another example of the satellite radio-controlled wristwatch 1, and corresponds to FIG. 19. In the example of FIG. 22, a dielectric part 328 included in the bezel 32 is integrally formed so as to include a part corresponding to the dial ring 34 of FIG. 19. The metal part 329 includes a lateral part that is fitted into the body 38 and supports the first part of the dielectric part 322, and a longitudinal part that is adjacent to the side wall of the dielectric part 322 and the side wall of the watch glass 31 and constitutes the side wall of the bezel 32.

In the examples of FIGS. 19 and 22, a dielectric is not included in the side surfaces of the antennas 10a and 10b. In this configuration, a packing formed of a high dielectric may be preferably disposed so as to achieve a larger wavelength shortening effect. Further, the conductive pins 41 may preferably supply power to the outer side of the center of the antennas 10a and 10b in the width direction so as to reduce the effect of the metal parts 323 and 329 on the received signal of the antennas 10a and 10b. In the examples other than the example of FIG. 22, the bezel 32 and the dial ring 34 may also be integrally formed.

The case has been explained in which the present invention is applied to the satellite radio-controlled wristwatch 1, although the present invention may be applied to a portable small timepiece different from a wristwatch, for example.

The invention claimed is:

1. A portable radio-controlled watch comprising:
a watch glass;
an antenna electrode that is formed on a backside of a peripheral edge of the watch glass so as to be along the peripheral edge;
a receiving circuit;
an antenna connecting line that is at least a part of a connection circuit connecting the antenna electrode with the receiving circuit, the antenna connecting line being directly connected to a back surface of the antenna electrode and extending in a direction away from the watch glass; and
a dielectric that is disposed below the antenna electrode and covers at least a part of the antenna electrode in a plan view.

2. The portable radio-controlled watch according to claim 1, further comprising a bezel into which the watch glass is fitted, wherein
the dielectric is a part of the bezel and disposed immediately below the antenna electrode.

3. The portable radio-controlled watch according to claim 1, further comprising a bezel into which the watch glass is fitted, wherein
the dielectric is a part of the bezel, and an insulating member is disposed between the antenna electrode and the dielectric.

4. The portable radio-controlled watch according to claim 1, further comprising:
a bezel into which the watch glass is fitted and includes a dielectric disposed below the antenna electrode; and
a dielectric member that is disposed between the dielectric and the antenna and has a different permittivity than the dielectric.

5. The portable radio-controlled watch according to claim 1, further comprising a bezel into which the watch glass is fitted and includes a metal member and a dielectric member.

6. The portable radio-controlled watch according to claim 1, further comprising a hiding member between the antenna electrode and the watch glass.

7. The portable radio-controlled watch according to claim 1, wherein
a peripheral edge of the watch glass is inclined in a front side.
